(19) United States
(12) Patent Application Publication
(10) Pub. No.: US 2009/0327111 A1
(43) Pub. Date: Dec. 31, 2009

(54) BILL PAYMENT IN ASSOCIATION WITH TELEVISION SERVICE PROVIDERS SYSTEMS AND METHODS

(75) Inventors: Kurt Bulawa, Parker, CO (US); Terra Geiger, Boulder, CO (US); Gail Galuppo, Lone Tree, CO (US); Scott Paintin, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 12/495,225

(22) Filed: Jun. 30, 2009

Related U.S. Application Data
(63) Continuation-in-part of application No. 12/189,950, filed on Aug. 12, 2008.
Application No. 12/189,950 is a continuation-in-part of application No. 11/863,906, filed on Sep. 28, 2007.

(51) Int. Cl. G06Q 20/00; G06Q 30/00; G06Q 40/00

(52) U.S. Cl. 705/34; 705/40

(57) ABSTRACT

Systems, methods, and devices for a television-based bill payment system are disclosed. The methods and systems include a television system that is configured to receive and transmit user-specific information and to display a user interface. The methods and systems also include a television provider network that is operated by a television service provider, configured to transmit and receive user-specific information with the television system and the television service provider network is configured to communicate with a bill payment provider. The methods and systems include a bill payment provider that communicates with the various billers. The bill payment provider is configured to communicate with the user through the televisions service provider network, and the bill payment provider is configured to bill a funding source selected by the user from the one or more funding sources.

### CROSS-REFERENCES TO RELATED APPLICATIONS

This application is a non-provisional application. It is a Continuation-in-Part of U.S. patent application Ser. No. 12/189,950, Attorney Docket No. 026595-011600US, filed on Aug. 12, 2008, entitled METHODS AND SYSTEM FOR MONEY TRANSFER WITH CABLE AND/OR SATELLITE PROVIDERS, and a Continuation-in-Part of U.S. patent application Ser. No. 11/863,906, Attorney Docket No. 026595-009900US, filed on Sep. 28, 2007, entitled BILL PAYMENT AGGREGATION SERVICE. This Application hereby incorporates by reference the content of the aforementioned applications in their entirety and for all purposes.

### BACKGROUND OF THE INVENTION

Embodiments of the present invention relate in general to payments, and in particular, to the payment of bills, services, goods, and the filling of prepaid accounts through a television provider's network.

Many people now fund a variety of expenses through electronic methods instead of through paper methods. For example, in the past, a consumer may have received a bill from a biller in the mail. The consumer may then have paid the bill by placing a signed check in an envelope and mailing it to the biller. Today, the consumer may be able to pay the same bill electronically through her bank. With such a payment method, the consumer may receive an electronic notification that a bill has been received and is ready to be viewed. The consumer may then be able to login to a website, view the bill, the amount due, the date due, and make an electronic payment. This method may be seen by the customer as having many benefits. The consumer may save money by not having to purchase postage for mailing a check, she may save time by not having to write the check and find a mailbox, and she may benefit from increased flexibility by being able to specify the date the bill is paid. In many cases, this may mean the consumer specifies the last possible date the bill may be paid before the bill becomes overdue.

While online bill payment has many advantages, it also may be seen as having several limitations. For example, typically bill payment occurs via a webpage. This may require the consumer to have Internet access at home or at work to complete an electronic bill payment transaction. Also, bill payment is typically conducted through a financial institution where the consumer maintains an account. For example, a bank where the consumer has a checking account. Further, some financial institutions may charge a customer a fee, such as a monthly fee, for the convenience of having online bill payment.

Due to these limitations, a portion of the population may not be able to take full advantage of online bill payment systems. This portion of the population may not have Internet access, a bank account, or a bank account that allows for electronic bill payment. Systems and methods that allow for consumers to make bill payments electronically without requiring Internet access or a bank account may increase the number of people able and willing to electronically pay bills. This invention serves to remedy these and other problems.

### BRIEF SUMMARY OF THE INVENTION

In some embodiments, a television-based bill payment system is present. The system includes a television system that is configured to receive and transmit user-specific information and to display a user interface. The system may also include a television provider network that is operated by a television service provider. It is also configured to transmit and receive user-specific information with the television system and the television service provider network is configured to communicate with a bill payment provider. The system further includes a user interface. The user interface is configured to display on the television system and provides a user with various billers to select from and one or more funding sources to select from. Finally, the system includes a bill payment provider that communicates with the various billers. The bill payment provider is configured to communicate with the user through the televisions service provider network, and the bill payment provider is configured to bill a funding source selected by the user from the one or more funding sources. Such a system may allow a user to complete a bill payment transaction without having internet access.

In some embodiments, the user may use cash as a funding source. This may allow the user to complete a bill payment transaction without having access to the internet or a bank account.

In some embodiments, a method of making bill payments executed in connection with cable or satellite providers or both is present. The method includes receiving billing information from a biller for a bill due from a user. The method also includes storing the billing information from the biller on a computer-readable medium. An interface is presented to the user on a television system via a television service provider's network, such as a cable provider or a satellite provider. The method further includes, receiving identification information from the user, this information is linked to an account of the user. This user identification information is verified. At least some of the billing information received from the biller is transmitted to the user via the television system. A bill selection and funding source selection(s) by the user are received and stored. Such a method may allow a user to pay bills via a television service provider's network whether or not the user has an account with the television service provider.

In some embodiments of the invention, the method includes transmitting a transaction identifier to the television system user via the television service provider's network. A confirmation may be received at the bill payment provider from the bill payment provider-operated location or an agent location. Such a method may allow a user to pay a bill with cash by providing the cash to an agent of the bill payment provider.

In some embodiments of the invention a method for television-based user-independent payments is present. The method includes receiving a selection of an item or service for purchase via a television service provider network. The method also includes determining a biller associated with the selection of the item. The method further includes transmitting a request for user identification via the television service provider network. The user information is validated. A selection of a funding source is received from the user. A payment confirmation is sent to the biller.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

FIG. 1 is a simplified block diagram of an embodiment of a bill payment system using a television service provider's network.

FIG. 1b is a simplified block diagram of an embodiment of a bill payment system 100b using a television service provider's network and a computer-based network.

FIG. 2 is an embodiment of a user interface for a bill payment system using a television service provider's network.

FIG. 3 is a simplified block diagram of an embodiment of a bill payment method using a television service provider's network.

FIG. 4 is an embodiment of a continuation of the method of FIG. 3 for when a user pays with cash.

FIG. 5 is a simplified block diagram of an embodiment of a purchase payment method using a television service provider's network.

FIG. 6 is an embodiment of a continuation of the method of FIG. 5 when a user desires to pay with cash.

### DETAILED DESCRIPTION OF THE INVENTION

Devices, systems, and methods are described for the implementation of a novel architecture for receiving and sending payments through a television provider's network. A bill payment entity, such as a financial institution, may receive bills and billing information from a number of billers. This bill payment entity may communicate with a number of television service providers. In turn, these television service providers may each have a number of customers. A television service provider may be a cable television company, a satellite television company, or any other company that provides television services. Further, the television service provider may provide services that displays bills using a television, as opposed to traditional television programming. Such a television service provider may include a gaming network or gaming console network provider. Each television service provider may already provide customers with a user interface. This user interface may have a menu system associated with it. An item may be added to the menu system allowing interaction with a bill payment entity. Such an interface may automatically be logged in to the bill payment entity based on the customer's account with the television service provider or may require a separate login process with the bill payment entity.

A biller or vendor may be able to send a user of a television service provider a bill via the bill payment entity. The biller may transmit the bill to the bill payment entity, then the bill payment entity may transmit the bill to the customer's television system via the television service provider's network. Alternatively, the biller or vendor may transmit the bill to the television service provider, which then sends the bill to the customer's television system. The customer may be provided with a display that lists a number of pending bills from a variety of billers. The display may also include historical payment information for each biller. The display may also be customized by the user. The television service provider may also display a popup icon to indicate that a new bill has arrived for payment. The billers may provide services. The billers may be entities such as mortgage companies, prepaid services, automotive loan companies, credit card companies, government entities, merchants, utilities or service providers providing services such as electricity, natural gas, sewer services, television service, broadband service, water, home heating oil, and landscaping work. The billers may also provide goods. A biller may be a website based merchant, a television shopping network, a store, or a person such as a neighbor you owe money to.

A customer may be able to send funds to a vendor, biller or multiple billers at the same time. The customer of the television service provider may specify a payment source, such as the customer's account with the television service provider or a bank account, a credit card, cash, prepaid account, or a checking account, to transfer funds to the vendor, biller or billers. The customer may be required to provide additional information (e.g., routing number, Personal Identification Number (“PIN”), Card Verification Value (“CVV”), etc.), which may be provided through the interface or through an out-of-band channel. If the user specifies cash, a bill may be placed in a pending stage and the user may be provided with a transaction identifier. The customer may then pay in cash at an agent location, branch, kiosk, or ATM of the bill payment entity, thereby allowing the user to complete the electronic bill payment transaction with cash.

The flexibility of such a bill payment system allows for a large variety of situations to be handled. For example, a user may wish to purchase a pay-per-view movie via a television. In many instances, a purchase such as this will appear as an item on the bill associated with the television service provider the purchase was made from. However, the person desiring to watch the pay-per-view movie may not be the same person who receives the bill. Therefore, the person may desire to pay for the pay-per-view-movie separately. A separate payment may have distinct benefits: the movie-watcher would not need to remember to reimburse the person responsible for the television service provider's bill, the person responsible for the television service provider's bill may not be made aware of the purchase (especially useful if the movie contains material of a private nature), and the user may be able to pay for the service immediately, thereby saving the user from having to allocate funds for the pay-per-view movie at a later time.

Such a system may be beneficial in many other situations, such as during a hotel stay. Many business travelers are reimbursed for their hotel rooms by their employers. However, employers may not reimburse the business travelers for extraneous purchases, such as drinks at the hotel bar, mini-bar purchases, in-room entertainment such as movies or video games, or room service. A business traveler may still wish to purchase such goods or services using their own money and not have the goods or services appear on the hotel bill that may need to be submitted to his employer. A system that allows a user to log in via a television in a hotel room and provide payment for goods or services may save the business traveler the hassle of reimbursing the employer at a later time or explaining a potentially embarrassing charge to a superior.

Further, the system allows a user to log in via a television from any properly equipped terminal and provide payment for goods or services regardless of where the consumer is. Therefore, a consumer may make emergency payments from his home, a friend's home, a hotel, or any other place with a properly equipped television terminal.

Further, a hotel may require that all charges be paid for before service is rendered. Such a system may require a hotel guest to provide payment via the television system in the hotel room prior to room service being delivered or a pay-per-view movie being shown. This may benefit the hotel by reducing the amount of a deposit the hotel guest is required to provide and may reduce the amount of services or goods that are provided by the hotel that are never paid for.

The use of such a bill payment system may include a fee being charged to a customer, a hotel, a biller, and/or a television service provider. Examples of possible systems and methods for charging a fee for the use of such a bill payment system may be found in U.S. Pat. No. 7,392,940, entitled “IN-LANE MONEY TRANSFER SYSTEMS AND METHODS,” the entire disclosure of which is incorporated for all purposes.

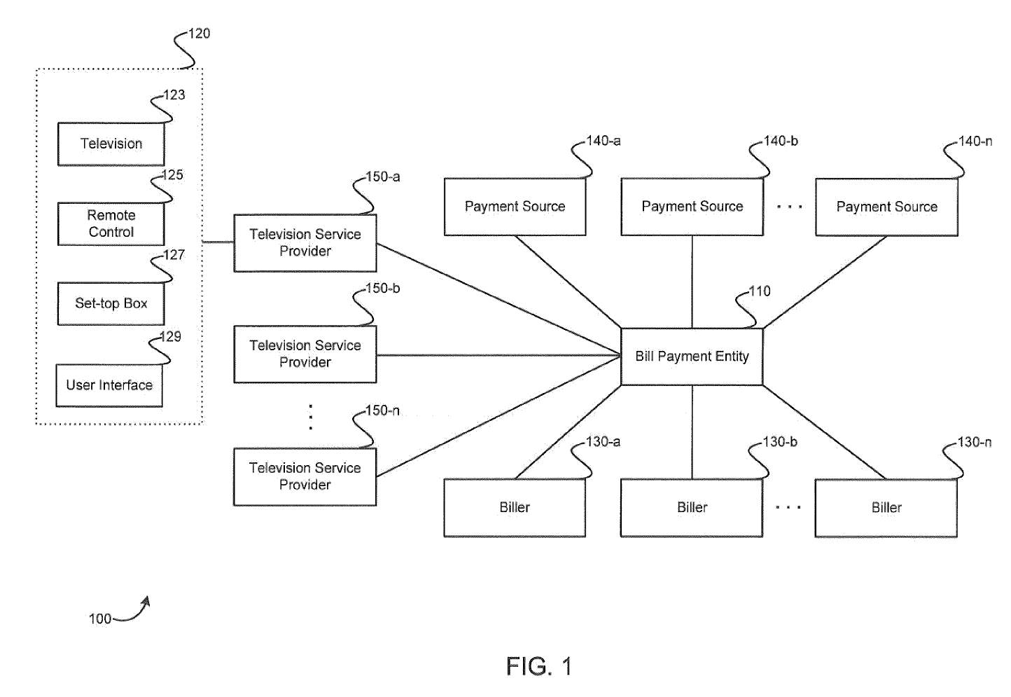

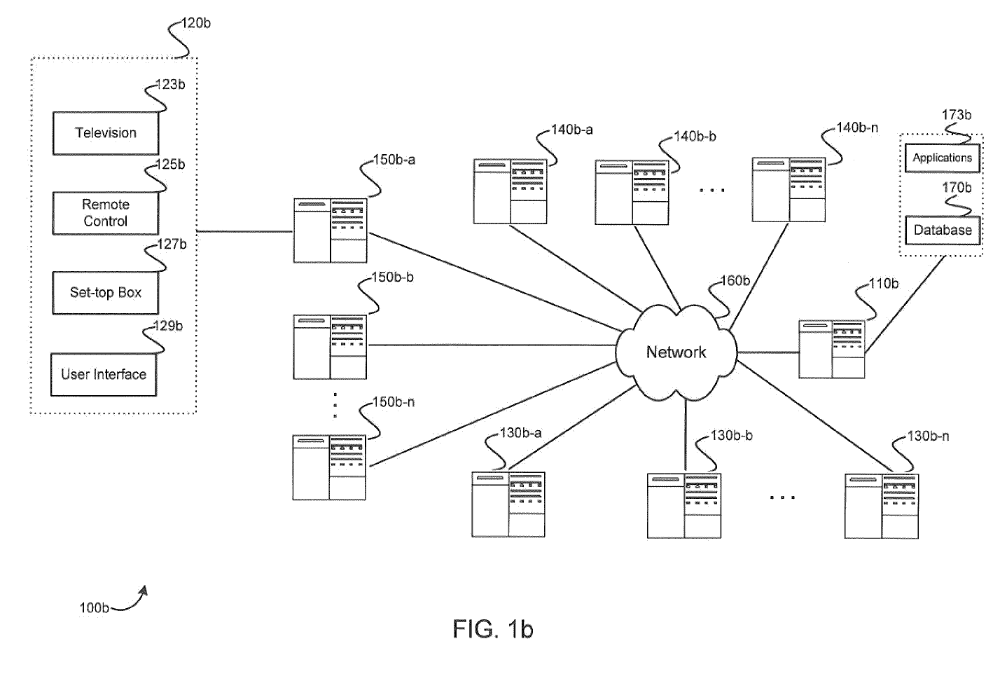

FIG. 1 is a simplified block diagram of an embodiment of a bill payment system 100 using a television service provider's network. A bill payment entity 110 may have a relationship with a number of billers 130 and television service providers 150-a and vendors. The bill payment entity 110 may be a financial institution, such as a bank or other financial service provider. The bill payment entity 110 may be able to guarantee funds for the transactions. For example, when a consumer makes a payment, that money may be kept by the bill payment entity 110, with other funds being transferred either immediately or at some later time, to the billers 130 by the bill payment entity.

The billers 130 may be any number of different companies, merchants/vendors of goods, service providers, private parties, persons, investment firms, lenders, collection agencies, charities, stores, or any other person or institution that is capable of receiving monetary funds. For example, biller 130-a may be a power company and biller 130-b may be a television shopping network. Billers 130 may have accounts with bill payment entity 110. At a predetermined time or randomly, billers 130 may transmit one or more bills for one or more customers to bill payment entity 110. The biller may have been previously notified that a customer wishes to receive a bill electronically, or the biller may transfer all bills to a bill payment entity 110 regardless of whether a customer currently pays bills via a television service provider's network to a bill payment entity 110. The biller may notify the bill payment entity 110 to notify the customer that the bill is now available. The biller may have no existing relationship with the bill payment entity, in which case at least some of the bill information may be provided to the bill payment entity by the customer, the television system and/or television service provider. Bill information may include the biller's name, address, or telephone number, account number, amount to be paid, nature of goods or services provided, etc.

The bill payment entity 110 may have a relationship with one or more television service providers 150. Each of the television service providers 150 may connect to any number of television systems. For simplicity, only one television system 120 is shown in FIG. 1. More than one customer may use the same television system. At predefined times, a bill payment entity 110 may transfer a number of bills to a television service provider 150-a for distribution to customers. For example, every night a batch transaction between the bill payment entity 110 and the television service provider 150-a may send a number of bills to the television service provider. Alternatively, as each bill is received by the bill payment entity 110 from a biller 130-a, the bill may be transmitted to the television service provider 150-a. In some embodiments, no billing information is transmitted from the bill payment entity 110 to the television service provider 150-a until requested by the television service provider 150-a or customer. For example, the television service provider 150-a may wait until a request is received from a customer for billing information, at which time the television service provider 150-a may request billing information from the bill payment entity 110. The bill payment entity 110 may then send a bill or number of bills to the customer via the television service provider 150-a. In this manner, the television service provider 150-a may not need to maintain any records regarding a user and bill payment. The television service provider may always function as a conduit, serving as the network the customer communicates with the bill payment entity through. Alternatively, the television service provider may function as more than only a conduit by receiving, processing, and transmitting information sent from the customer to the bill payment entity. Also, a biller (e.g., a television shopping network or content provider) may have a direct relationship with a television service provider. Such a relationship could allow the biller to send a bill to a customer directly through the television service provider rather than through the bill payment entity. Following receipt of such a bill, the customer could use the bill payment entity to pay the bill. Billing information could be provided to the bill payment entity by the biller, vendor, television service provider, television system and/or customer.

While the application refers to “television service providers,” it should be understood that other service providers are suitable in place of television service providers. For example, a gaming service provider may serve the same function. Likewise, a gaming system, such as a NINTENDO WIT, SONY PLAYSTATION, or a portable player, such as a NINTENDO GAMEBOY may serve as the television system 120. The gaming system may then connect to a gaming service provider 150. This gaming service provider 150 may then functionally interact with the bill payment entity 110 and the gaming system 120. The gaming service provider 150 may be the manufacturer of the gaming system 120 or may be a third-party provider. Such a provider may connect to the gaming system 120 via the Internet, a direct connection, a satellite connection, a cellular connection, or any other suitable networking connection.

Likewise, an authentication process for bill payment may not require any stored information, or only a minimal amount of stored information, by the television service provider 150-a. A customer may be required to login to the bill payment entity 110 and/or television service provider before paying bills or viewing bills. While the information transfer may occur via the television service provider's 150-a network, the user information may be maintained by the bill payment entity 110, the television service provider, or both. For example, the customer may be required to input a username and a password in order to verify her identity with the bill payment entity 110. Such a login process may provide benefits beyond security. For example, this may allow a person who does not have an account with a television service provider 150-a to pay bills electronically. For example, while one roommate may be the account holder with a television service provider 150-a, another roommate may be the account holder with the power company. A separate login with the bill payment entity 110 may allow each to maintain separate accounts for receiving and paying bills.

The television service provider 150-a may communicate with a television system 120. The television system 120 may be present in a customer's home, business, or other location. A television system 120 may be viewed as one or more televisions and/or computers receiving service from the television service provider. For example, customers often receive service from a television service provider 150-a at multiple televisions in a household. A television system 120 may include several components, including a television 123, a remote control 125, a set-top box 127, and a user interface 129 displayed on the television and/or computers. Television system 120 may require the use of a set-top box 127, or may not. The set-top box 127, the television 123, or the remote control 125 may serve as an input device for a customer to interact with the television service provider 150-a and the bill payment entity 110. A keyboard (wireless or directly connected to the television or computer) may also serve as an input device.

The remote control 125 may be a standard television remote that allows a user to interact with the television system 120 and the television service provider 150-a. The remote control 125 may include arrow keys or some equivalent that allows a user to select various displayed menu items. In some embodiments, the remote control 125 may be a gaming controller. Such a controller may similarly allow a user to scroll or move through various on-screen selections. The remote control 125 may be wired or wireless. In some embodiments, the remote control 125 may be a smartphone, such as an APPLE IPHONE, or RIM BLACKBERRY, that may be able to communicate with a television, television set top box, television service provider, bill payment entity, biller and/or vendor though near-field communication (e.g. Bluetooth), cell towers, satellite, or any combination thereof. The smartphone may have one or more applications for communicating with the television, television set top box, television service provider, bill payment entity, biller and/or vendor and/or for displaying and/or making bill payments or purchases. The remote control may utilize voice recognition technology, which may be used in whole or in part to identify and/or authenticate the customer, or to receive information relating to a bill, biller and/or the bill payment service (e.g., receive biller information, receive payment source information, receive instructions from the customer to pay one or more bills, etc.)

The customer may have the opportunity to select from a number of payment sources 140. A customer may have a number of debit/credit card accounts, bank accounts, checking accounts, savings accounts, prepaid accounts, or stored value accounts, investment accounts, mobile wallet, etc. The customer may be able to save one or more payment sources to or with the remote control, television, television set top box, television service provider, bill payment entity, biller and/or vendor. With some payment sources, the customer may be required to provide additional information such as routing number, PIN or CVV, either through the interface or an out-of-band channel. Cash may be a payment source 140. An advance charged to the customer's television service provider account may be a payment source. A customer may wish, or be required, to pay certain bills from a particular payment source 140-a, while paying others from a different payment source 140-b. For example, a customer may wish to pay her energy bill from her checking account. This same customer may wish to pay her television shopping network bill with her American Express charge card. A customer may be given the opportunity to register varying payment sources 140 with the bill payment entity 110. For example, by default no payment sources 140 may be listed on the user interface 129 for the user. The user may then add a payment source 140-a by identifying the financial institution associated with the payment source, the account number, the routing information or any other pertinent information required by the bill payment entity 110. A customer may then be able to select the payment source 140-a without re-entering the bulk of the account information.

The user interface 129 may be created and maintained by the television service provider 150-a, or may be created and maintained by the bill payment entity 110. Some television service providers 150 may desire to maintain complete control over all material and format of the material presented to a customer for quality control purposes. Therefore, while information may be transmitted from the television system 120 to the bill payment entity 110 with minimal or none of the information being used by the television service provider 150-a, the television service provider 150-a may create and maintain the user interface 129 the customer uses to interact with the bill payment entity 110. In other embodiments, the bill payment entity 110 may distribute a user interface 129 through the television service provider 150-a to the television system 120. In some embodiments, the user interface 129 may be transmitted from the bill payment entity 110 to the television system 120 during, prior to or after an initial transaction or registration or may be transmitted each time a customer interacts with the bill payment entity 110.

FIG. 1b is a simplified block diagram of an embodiment of a bill payment system 100b using a television service provider's network and a computer-based network. The bill payment system 100b may be the same bill payment system as bill payment system 100 of FIG. 1, or it may be some other embodiment of a bill payment system. Each component designated in FIG. 1 may have a corresponding computer component in FIG. 1b. For example, payment source 140b-a of FIG. 1b may correspond to the same payment source as payment source 140-a of FIG. 1. Each server or computer illustrated in FIG. 1b may include a number of computers or computer devices. The computers may be servers. The computers may include a display, a computer-readable storage medium, and a processor. The computer-readable storage medium may be a RAM, a ROM, a hard-drive, etc. Each of these computers, servers, or computerized devices may be capable of communicating with other computers, servers, or computerized devices via a network 160b. Instructions for processing and the various interactions between the computers may be stored in the form of computer-readable instructions on the computer-readable storage medium.

Certain embodiments of the invention operate in a networked environment, which can include the network 160b. The network 160b can be any type of network familiar to those skilled in the art that can support data communications using any of a variety of commercially-available protocols, including without limitation TCP/IP, SNA, IPX, AppleTalk, and the like. Merely by way of example, the network 160b can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth protocol known in the art, GSM, TDMA, CDMA, a mesh network and/or any other wireless protocol; and/or any combination of these and/or other networks.

Embodiments of the invention can include one or more server computers, such as 110b, 130b, 140b, and 150b. Each of the server computers may be configured with an operating system, including without limitation any of those discussed above, as well as any commercially (or freely) available server operating systems. Each of the servers may also be running one or more applications 173b, which can be configured to provide services to one or more clients and/or other servers.

Merely by way of example, one of the servers may be a web server, which can be used, merely by way of example, to process requests for electronic documents from the television system 120b. The web server can also run a variety of server applications, including HTTP servers, FTP servers, CGI servers, database servers, Java™ servers, and the like. In some embodiments of the invention, the web server may be configured to serve web pages that can be operated within a web browser on the television system 120b to perform methods of the invention.

The server computers, in some embodiments, might include one or more application servers, which can include one or more applications accessible by a client running on the television system 120b and/or other servers. Merely by way of example, the server(s) can be one or more general purpose computers capable of executing programs or scripts in response to the television system 120b and/or other servers, including without limitation web applications (which might, in some cases, be configured to perform methods of the invention). Merely by way of example, a web application can be implemented as one or more scripts or programs written in any suitable programming language, such as Java™, C, C# or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on the television system 120b and/or another server. In some embodiments, an application server can create web pages dynamically for displaying the information in accordance with embodiments of the invention. Data provided by an application server may be formatted as web pages (comprising HTML, Javascript, etc., for example) and/or may be forwarded to a television system 120b via a web server (as described above, for example). Similarly, a web server might receive web page requests and/or input data from a television system 120b and/or forward the web page requests and/or input data to an application server. In some cases, a web server may be integrated with an application server.

In accordance with further embodiments, one or more servers can function as a file server and/or can include one or more of the files (e.g., application code, data files, etc.) necessary to implement methods of the invention incorporated by an application running on a user computer 705 and/or another server. Alternatively, as those skilled in the art will appreciate, a file server can include all necessary files, allowing such an application to be invoked remotely by a another computer and/or server. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 170b. A database may be present on any computers or servers, but only one is illustrated for simplicity. The location of the database(s) is discretionary: merely by way of example, a database might reside on a storage medium local to (and/or resident in) a server. Alternatively, a database can be remote from any or all of the computers, so long as the database can be in communication (e.g., via the network) with one or more of these. In a particular set of embodiments, a database can reside in a storage-area network (“SAN”) familiar to those skilled in the art. (Likewise, any necessary files for performing the functions attributed to the computers can be stored locally on the respective computer and/or remotely, as appropriate.) In one set of embodiments, the database can be a relational database, such as an Oracle™ database, that is adapted to store, update, and retrieve data in response to SQL-formatted commands. The database might be controlled and/or maintained by a database server, as described above, for example.

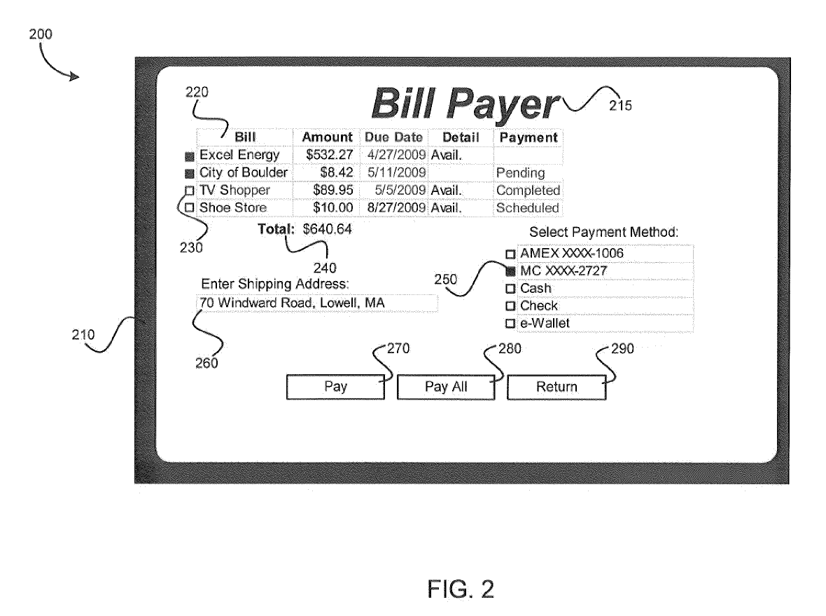

The user interface 129 may take many forms. FIG. 2 is an exemplary embodiment of a user interface 200 for a bill payment system using a television service provider's network. The user interface 200 may be user interface 129 of FIG. 1. Alternatively, the user interface 200 may be the user interface of some other bill payment system. The user interface 200 may include displaying the interface on a television screen 210 or computer screen. The user interface 200 may cover the entire television screen 210 or computer screen or a portion of the television screen 210 or computer screen.

In this embodiment, the user interface is entitled “Bill Payer” 215. In some embodiments, the user interface 200 may be branded with the bill payment entity's name or logo or the television service provider's name or logo, or any other title or logo desired by the television service provider or bill payment entity. Some embodiments may have its own brand name.

A chart 220 may be presented to display billing information to a customer. The chart 220 may include any or all of: the biller identity, the amount due, the due date, account information (which may be partially masked), a detailed bill, and a payment status. While this information may be presented in chart form, a person with skill in the art will recognize numerous ways of presenting billing information to a customer. Under the heading “Bill,” the entity billing the customer may be presented. This may be the same name as the biller providing the bill to the bill payment entity, or it may represent another company or brand name the biller interacts with. The “Amount” column of the chart 220 may list the current amount due to the biller. This may represent one billing period, such as a monthly energy bill, a product price, or a combination of multiple bills from the same biller. The “Due Date” column of the chart 220 may represent the last date the customer may be allowed to pay the bill without a the bill being overdue. A late fee may be attached to a bill that is paid after the due date. The “Detail” column of chart 220 may allow a user to select a particular bill and view more information. The word “Available” or some equivalent thereof may denote that a detailed bill is available for viewing. For example, if the bill is an energy bill, viewing the detailed bill may include information such as: the billing period, the energy units used, a comparison to the previous month or the same time period in the previous year, and the biller's telephone number. For some bills or billers, a detailed bill may not be available. Another column entitled “Payment” may be present in the chart 220. This column may indicate the payment status of a bill. Categories might include: “Completed,” “Pending,” “Partial,” and “Scheduled.” A Scheduled bill may be a bill or payment which the consumer has set to be automatically paid at a certain future date(s) or time(s) and may be a one time payment or may be recurring. Such an option may be useful if a consumer wishes to pay a bill on the last possible day before incurring a late fee from the biller. A Completed bill, one in which the biller, bill payment entity or television service provider has successfully received funds for may display as Completed for a period of time to remind the user she has successfully paid the bill. The chart 220 may include any other information pertinent to the transaction between a biller and the customer. A total 240 may be displayed showing a customer the total amount she owes to all billers. The chart may also include historical payment information and/or bill information. Any part of the chart may be made customizable by the customer. For example, the customer may be able to customize the chart layout or format, biller identities, or status categories. A customer may also be able to add information to the chart, such as bill category (e.g. utilities, mortgage, credit card payment, etc) The customer can enter the customized/added information and/or may be presented with pre-existing templates or dropdown menus.

A selection of buttons may be displayed on the user interface 200 for a customer to indicate her intended action. Buttons present may include: “Pay” 270, “Pay All” 280, and “Return” 290. “Pay” may indicate that a customer wishes to pay one or more bills. A selector system, such as checkboxes 230, may be present to allow a customer to select a particular or a set of particular bills. A user/customer may also choose to pay more (e.g. paying the loan installment currently due, plus an excess amount) or pay less (e.g., only paying an undisputed portion of the total amount due). Selecting “Pay” 270 may complete the payment for the selected bills, or bring the customer to a confirmation screen. A “Pay All” 280 button may allow a customer to pay all bills that have not been paid yet. In this embodiment, the total 240 would be paid, with the designated amount listed in chart 220 being paid to each associated biller. A “Return” 290 button may cancel the current action and return the customer to a previous screen, current television programming, or a menu.

Several other categories of selections may be present on the user interface 200. A customer may be able to enter a shipping address in a text box. This shipping address 260 may be used for any products the customer is to receive. For example, the shipping address 260 may be the customer's home address or work address for an item, a hotel, or may be another address (e.g., a friend or family member's house), if the item is to be a gift. A shipping address may also be automatically provided by the television service provider based on the billing address it has on file. A customer may also be able to select a payment method 250. Payment method 250 may correspond to a payment source, such as payment source 140-a in FIG. 1. The customer may be able to add new payment methods 250 or select from previously added or used methods. Checkboxes may be used to allow a user to specify a payment method 250. A customer may be allowed to pay a bill by one payment method 250, then complete a second transaction paying another bill using a different payment method 250. In some embodiments, a customer may be able to select more than one payment method 250 to pay one bill. This may be especially useful if the customer is paying a large bill that she wants payment spread between multiple accounts or credit cards. One possible payment method 250 may be an e-wallet. An e-wallet may be a prepaid account of the consumer from which the consumer may complete payments. This e-wallet may be maintained with the bill payment entity, television service provider, financial service provider, telecommunications provider, or some other entity. The bill payment provider interface may also include a view of the consumer's historical bill payment information.

If cash is selected as a payment method 250, a separate process may need to be followed. As physical currency cannot be submitted through a television system or user interface 200, a bill payment may not be able to be fully completed from the television system. If cash is selected as a payment method, the customer may be provided with a customer transaction identifier. The customer transaction identifier may be provided by the bill payment entity directly to the customer or may be provided by the biller or television service provider to the customer and to the bill payment entity. The bill may be placed in a payment pending status until cash is received by the bill payment entity. A customer may be instructed to proceed to an agent location of a bill payment entity. A bill payment entity may have thousands of agent locations scattered across a nation or the world capable of receiving cash payment. The user interface 200 may provide the customer with a map of local agent locations, branch locations, kiosks or ATMs where cash may be submitted. These locations may be searchable by zip code or other location information. These locations also may be presented based on a determination of the customer's location by GPS, triangulation or similar means (e.g., comparing the customer's current location against a database of locations to provide location information about one or more nearby locations to the customer). Location information may include an address, map, directions, operating hours, service types available, currencies accepted, languages spoken, fees, etc. Upon completing a cash payment, the payment heading in the chart 220 may be updated to Completed.

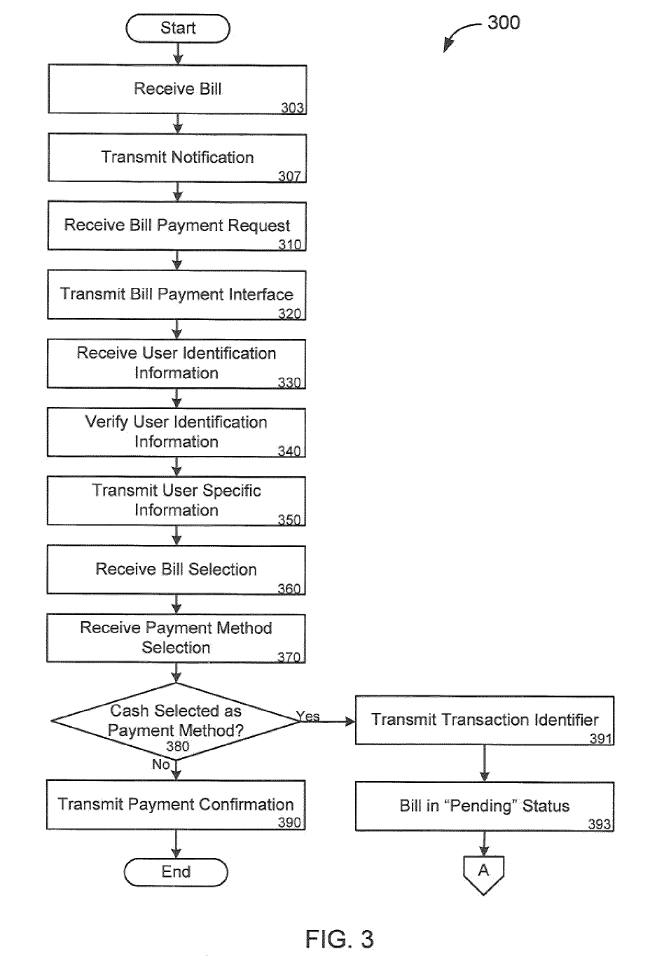

FIG. 3 illustrates a simplified block diagram of an embodiment of a bill payment method 300 using a television service provider's network. Such a method may be used on the bill payment system 100 of FIG. 1, or a different bill payment system. Such a method may involve the use of the user interface 200 of FIG. 2, or a different user interface.

First, a bill payment entity may receive 303 a bill from a biller. The bill may be sent to the bill payment entity by the biller as soon as the bill becomes available, or a batch transaction sending many bills to the bill payment entity may occur at a predefined time. In some embodiments, the bill payment entity may query the biller to determine if any new bills are available, or if a bill is available for a particular customer. The bill information received by the bill payment entity may be minimal, such as one or more of the amount due, the due date, the billing address, a customer's identifier, and a transaction identifier or it may be detailed, containing specifics on the goods or services rendered. The bill information received 303 by the bill payment entity may include an image, such as .pdf of a bill that appears similar to a paper bill a consumer would receive in the mail.

After receiving a bill, the bill payment entity may transmit 307 a notification to a consumer that she has a bill ready to be viewed and paid. The notification may appear on the screen of the consumer's television, such as a highlighted menu item. The notification may also arrive via a separate medium, such as text message, email, phone call, fax, or paper mailing. The notification may provide a link for the customer to access the bill.

The bill payment entity may then receive 310 a bill payment request. This bill payment request may include the selection of a menu item on the television service provider interface requesting a bill payment interface, such as the user interface 200 of FIG. 2. The bill payment entity may then transmit 320 the bill payment interface. In some embodiments, the interface is transferred to the consumer's television system by the television service provider. In some embodiments, the bill payment interface may be stored locally at the customer's television system.

The bill payment entity may then receive 330 user identification information. User identification information may be provided by the television service provider or by the customer. If the television service provider provides the user identification information, it may be associated with the account holder with the television service provider. If the customer is required to input the user identification information, it may include a username and a password. Alternatively, it may be a name, address, telephone number, social security number, loyalty program number, email address, biometric data, a voice sample, or any other way of uniquely identifying a person. Some user identification information may be obtained through the bill payment interface or television service provider interface and/or some user identification information may be obtained through other out-of-band channels. For example, when one or more pieces of user identification information is received through an interface associated with a hotel room, the bill payment entity may request additional user identification information be provided by other means (e.g. text message from a wireless number known to be the customer's).

The user identification may then be verified 340 at the bill payment entity. Alternatively, the user identification information may be verified 340 at the television system of the consumer or the television service provider's system. Verification may occur by comparing the user supplied information against information stored in one or more databases.

The bill payment entity may then transmit 350 user specific information. This information may include outstanding bills, amounts due, due dates, the customer's preferences, saved payment methods, or any other customer specific information. Alternatively, this information may be transmitted 350 to the television system as the information becomes available with the information not being displayed until user identification information is verified 340.

The bill payment entity may then receive 360 a bill selection. Such a bill selection may be in the form of checkboxes, such as checkboxes 230 illustrated in FIG. 2. Persons with skill in the art will recognize there are many ways of identifying a selection via a television system. One or more bills may be selected. If multiple bills are selected, the customer may only be required to make one payment for the total amount due to the bill payment entity which then distributes the sums associated with the individual bills to the individual billers. The bill selection may be received 360 by the bill payment entity or the television service provider immediately. Alternatively, the bill selection may not be transmitted until the customer confirms her desire to make a payment, such as by clicking a button marked “Pay.” Some bills may be paid immediately while others are added to a queue for later payment. The customer may have the ability to add billers to his list that may be selected from a database of billers provided by the bill payment provider or billers may be added by the customer herself by inputting biller information.

A payment method selection may then be received 370 by the bill payment entity from the customer's television system via the television service provider. Such a bill selection may be in the form of checkboxes. One or more payment methods may be used for each bill payment transaction (e.g., credit, debit, ATM, automated clearing house, stored value, alternative value such as loyalty points, etc.). With some payment methods, the customer may be required to provide additional information such as routing number, PIN or CVV, either through the interface or an out-of-band channel. If multiple payment methods are selected for a transaction, the customer may be prompted to enter the breakdown of amounts or percentages desired to be funded by each payment method. In some embodiments, the bills may be divided equally among the selected payment methods. The payment method selection may be received 370 by the bill payment entity or the television service provider immediately. Alternatively, the bill selection may not be transmitted until the customer confirms her desire to make a payment, such as by clicking a button marked “Pay.”

If cash has not been selected 380 as a payment method, a payment confirmation may be transmitted from the bill payment entity or the television service provider to the television system. It may display on the screen as a message with a phrase such as: “Thank you for your payment to The Power Company for $532.27; this payment will be posted to the biller within 2 business days.” Alternatively, the payment confirmation may not be transmitted to the customer until the biller has confirmed receipt of the funds. In some instances, the payment confirmation may be transmitted 390 by one or more alternate modes, such as a text message, telephone call, fax, webpage, or email.

If cash has been selected 380 as a payment method, the customer may be provided with a transaction identifier. This transaction identifier may be transmitted 391 from the bill payment entity to the television system of the customer via the television service provider's network. In some embodiments, the transmitting 391 of a transaction identifier is unnecessary: the customer's username and/or password or other user identification information may function as the transaction identifier.

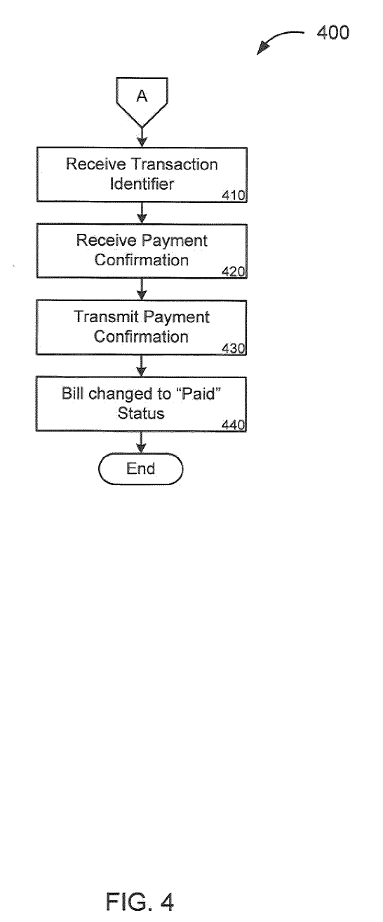

A bill may then be placed in “pending” status at the bill payment entity. The bill may display as such on the user interface displayed on the television system. A demarcation of “pending” may serve to remind the customer to visit an agent location, branch location, kiosk location, or ATM location of the bill payment entity. In some embodiments, a reminder will be periodically displayed on the customer's television system to remind her to remit the cash payment. The remaining steps of a cash payment may be performed by the customer at an agent location, branch location, a kiosk or ATM. The remaining steps of the method of FIG. 3 is illustrated in FIG. 4.

Once the bill has been placed in a pending status, the bill may remain in this state until the customer makes payment at an agent location of the bill payment entity. FIG. 4 is an embodiment of a continuation of the method 400 of FIG. 3 when a user desires to pay with cash. The transaction identifier provided to the customer by the bill payment entity may be received 410 by the bill payment entity at an agent location, branch location, kiosk, or ATM. In some embodiments, the transaction identifier may be the customer's user name and/or password.

A payment confirmation may be received 420 by the bill payment entity. This payment confirmation may be an acknowledgement that an agent, bank, or bill payment entity has physically taken possession of the amount of cash necessary to pay the bill or bills. In some embodiments, the customer may also pay with methods besides cash. For example, the customer may desire to pay with a credit card in person because he is afraid of having his credit card number stolen if transmitted via a television service provider's network. Other payment methods, such as debit, prepaid, stored value, ACH, check money order, mobile wallet, loyalty program value, etc., may be possible.

A payment confirmation may also be transmitted 430 by the bill payment entity. Payment confirmation may be in the form of a number (e.g. a money transfer control number). Such a payment confirmation may go to multiple places. For example, the confirmation may be transmitted to the customer's television system via the television service provider from the bill payment entity the next time the user logs in to the bill payment system. Such confirmation may appear in the form of the “Pending” status of a bill being changed to “Completed.” A confirmation may also be transmitted 430 via a different medium to the customer, such as by email, text, phone call, webpage, fax, or paper mailing. A confirmation may also be transmitted 430 to the agent location, branch location, kiosk location, or ATM so that the customer is told that the payment has been received by the bill payment entity.

The customer may be provided with one or more receipts as evidence payment has been made. The bill may be changed 440 from a pending status to a “Completed” or “Paid” status at the bill payment entity. Such a change may be transmitted via the television service provider to the television system of the customer. The transmission to the television system of the customer may not occur until the next time the customer logs in to the bill payment system.

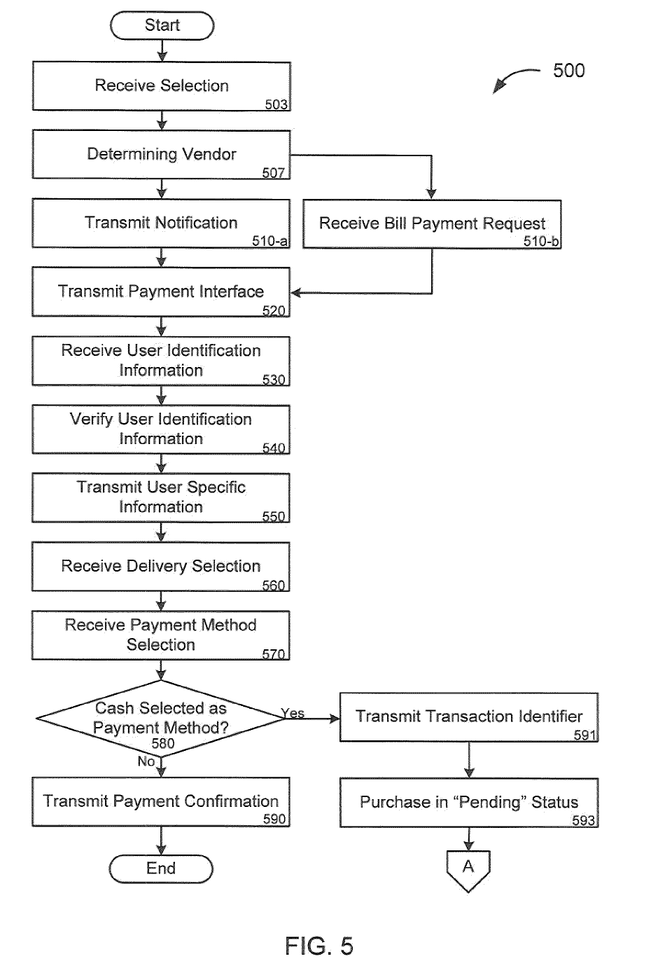

A method similar to method 300 of FIG. 3 may be used for the purchase of a good or service. FIG. 5 is an embodiment of a payment system 500 using a television service provider's network for the purchase of a good or service. Such a method may be used on the bill payment system 100 of FIG. 1, or a different bill payment system. Such a method may involve the use of the user interface 200 of FIG. 2, or a different user interface.

First, a bill payment entity, vendor and/or television service provider may receive 503 a selection of a good or service from a customer. The selection may occur via programming on the television system, such as an interactive home shopping network. In some embodiments, the customer may make a purchase from a television shopping network by selecting an item while it is displayed on the home shopping network. In other embodiment, a customer may be able to browse a selection of goods or services similarly to the way a computer user may browse an online store. In some embodiments, the user may be able to participate in an auction and bid on an item, with billing only occurring if the customer is the high bidder. A customer may make a selection, and this selection may be received by the bill payment entity, vendor and/or television service provider.

Once a selection has been received 503, a vendor associated with the selection of the good or service may be determined 507. This may be the television station associated with the good or service, a store, a manufacturer, or an auction holder. A bill may then be created by the bill payment entity, television service provider, the vendor, and/or the biller for the good or service with the sum of the good or service due to the vendor or biller responsible for the good or service. The vendor or biller may generate and transmit a bill to the bill payment entity. In some embodiments, the bill payment entity may generate the bill based upon information supplied by the television service provider, vendor, and/or biller.

After receiving a bill for a good or service, the bill payment entity may transmit 510-a a notification to a consumer that she has a bill ready to be viewed and paid. Depending on the good or service, bill payment may be due immediately. Such a payment may be substantially in real time with the biller either receiving funds or a confirmation that payment has been made substantially in real time. If payment is not made within a predetermined amount of time, such as 5 minutes or 5 days, the purchase may not be valid. The good may not ship or the service may not be performed until the bill is paid. If the customer wishes to complete a cash purchase, she may be allowed additional time to visit an agent, branch, kiosk, or ATM of the bill payment entity. The notification may appear on the screen of the consumer's television, as a highlighted menu item. The notification may also arrive via a separate medium, such as text message, webpage, email, phone call, fax, or paper mailing. The notification may provide a link for the customer to access the bill.

Alternatively, the bill payment entity may receive 510-b a bill payment request from the customer. A good or service may have been purchased or reserved without payment being due immediately. In such an instance, the customer may initiate the payment request with the bill payment entity. This bill payment request may include the selection of a menu item on the television service provider interface requesting a bill payment interface, such as the user interface 200 of FIG. 2.

Whether a payment request is received 510-b by the bill payment entity, or a notification is transmitted 510-a by the bill payment entity that payment is due immediately, the bill payment entity may then transmit 520 the bill payment interface. In some embodiments, the interface is transferred from the consumer's television system by the television service provider. In some embodiments, the bill payment interface may be stored locally at the consumer's television system.

The bill payment entity may then receive 530 user identification information. User identification information may be provided by the television service provider and/or by the customer. If the television service provider provides the user identification information, it may be associated with the account holder with the television service provider. If the customer is required to input the user identification information, it may include a username and a password. Alternatively, it may be any of a name, address, telephone number, social security number, email address, biometric data, a voice sample, or any other way of uniquely identifying a person. The customer may be required to provide some or all of the user identification information through an out-of-band channel.

The user identification may then be verified 540 at the bill payment entity. Alternatively, the user identification information may be verified 540 at the television system of the customer, the television service provider's system, and/or the vendor or biller. Verification may occur by comparing the user/customer supplied information against information stored in one or more databases.

The bill payment entity, television system, television service provider and/or vendor or biller may then transmit 550 user specific information. This information may include products, goods, and services purchased, taxes due, outstanding bills, amounts due, due dates, the customer's preferences, saved payment methods, or any other customer specific information. Alternatively, this information may be transmitted 550 to the television system as the information becomes available with the information not being displayed until user identification information is verified 540.

The bill payment entity may then receive 560 a delivery selection. Such a delivery selection may be a home address of the customer or a person who the good or service is to be delivered to. The delivery selection may be entered in the user interface in a text box such as text box 260 illustrated in FIG. 2. The delivery location may be selectable from a previous used list or provided by the customer. The delivery location may be the location associated with the customer's account with the television service provider, which may serve as a default delivery location unless changed by the customer. The delivery selection may be received 560 by the bill payment entity or the television service provider immediately. Alternatively, the bill selection may not be transmitted until the customer confirms her desire to make a payment, such as by clicking a button marked “Pay.”

A payment method selection may then be received directly 570 by the bill payment entity, from the customer's television system via the television service provider, and/or from the biller or vendor. Such a bill selection may be in the form of checkboxes if multiple goods and services are to be paid for. One or more payment methods may be used for each bill payment transaction. If multiple payment methods are selected for a transaction, the customer may be prompted to enter the breakdown of amounts or percentages desired to be funded by each payment method. In some embodiments, the bills or purchases may be divided equally among the selected payment methods. The payment method selection may be received 570 by the bill payment entity or the television service provider immediately. Alternatively, the bill selection may not be transmitted until the customer confirms her desire to make a payment, such as by clicking a button marked “Pay.”

If cash has not been selected 580 as a payment method, a payment confirmation may be transmitted from the bill payment entity or the television service provider to the television system. The confirmation may be received substantially in real time. It may display on the screen as a message with a phrase such as: “Thank you for your purchase of a fitted baseball cap for $19.95; this payment will be posted to the biller within 2 business days.” Alternatively, the payment confirmation may not be transmitted to the customer until the biller has confirmed receipt of the funds. In some instances, the payment confirmation may be transmitted 590 by one or more alternate modes, such as a text message, telephone call, fax, webpage, email, or paper mailing.

If cash has been selected 580 as a payment method, the customer may be provided with a transaction identifier. This transaction identifier may be transmitted 591 from the bill payment entity, television service provider, biller, or vendor to the television system of the customer via the television service provider's network. In some embodiments, the transmitting 591 of a transaction identifier is unnecessary: the customer's username and/or password or other user identification information may function as the transaction identifier.

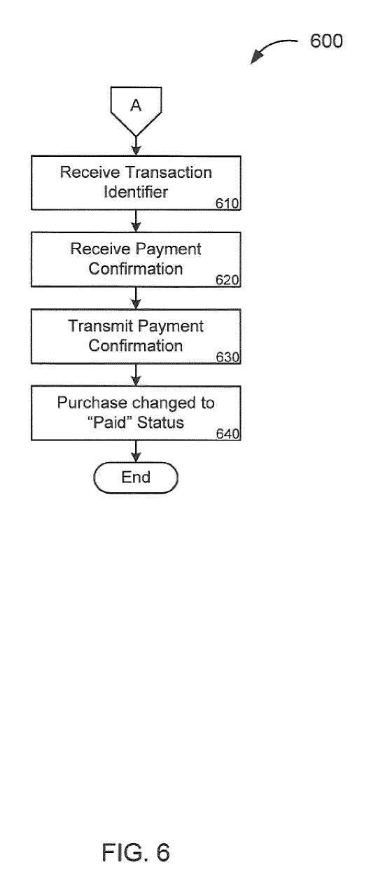

A bill may then be placed in “pending” status at the bill payment entity. The bill may display as such on the user interface displayed on the television system. A demarcation of “pending” may serve to remind the customer to visit an agent location, branch location, kiosk location, or ATM location of the bill payment entity. In some embodiments, a reminder will be periodically displayed on the customer's television system to remind her to remit the cash payment. If a customer does not complete the purchase in a certain amount of time, the purchase may be cancelled or a penalty fee assessed. The remaining steps of a cash payment may be performed by the customer at an agent location, branch, kiosk, or ATM. The remaining steps of the method of FIG. 5 is illustrated in FIG. 6.

Once the bill has been placed in a pending status, the bill may remain in this state until the customer makes payment at an agent location, branch, kiosk, or ATM of the bill payment entity. FIG. 6 is an embodiment of a continuation of the method 600 of FIG. 6 when a user desires to pay with cash. Such a method allows a customer to “stage” his payment via the bill payment system, with actual payment being completed at an agent location, branch, kiosk, or ATM. The transaction identifier provided to the customer by the bill payment entity television service provider, vendor or biller may be received 610 by the bill payment entity at an agent location, branch, kiosk, or ATM. In some embodiments, the transaction identifier may be the customer's user name and/or password and/or other user/customer information.

A payment confirmation may be received 620 by the bill payment entity. This payment confirmation may be an acknowledgement that an agent, branch, kiosk, or ATM has physically taken possession of the amount of cash necessary to pay the bill or bills. In some embodiments, the customer may also pay at the agent location, branch location, kiosk, or ATM with methods besides cash. For example, the customer may desire to pay with a credit card in person because he is afraid of having his credit card number stolen if transmitted via a television service provider's network. Other payment methods may include debit cards, stored value cards, ACH, money order, mobile wallets, a loyalty program, etc. With some payment methods, the customer may be required to provide additional information such as routing number, PIN or CVV, either through the interface or an out-of-band channel.

A payment confirmation may also be transmitted 430 by the bill payment entity, television service provider, and/or biller or vendor. Such a payment confirmation may go to multiple places. For example, the confirmation may be transmitted to the customer's television system via the television service provider from the bill payment entity, television service provider, and/or biller or vendor next time the user logs in to the bill payment system. Such confirmation may appear in the form of the “Pending” status of a bill being displayed as “Completed,” in an embodiment of a user display such as 200 of FIG. 2. A confirmation may also be transmitted 430 via a different medium to the customer, such as by email, text, webpage, phone call, paper mailing, or fax. A confirmation may also be transmitted 430 to the agent location so that the customer is told by the agent, branch, kiosk, or ATM that the payment has been received by the bill payment entity.

The bill may be changed 640 from a pending status to a “Completed” or “Paid” status at the bill payment entity, television service provider, biller, and/or vendor. Such a change may be transmitted via the television service provider to the television system of the customer. The transmission to the television system of the customer may not occur until the next time the customer logs in to the bill payment system.

In some embodiments, the bill payment system may handle the ad hoc purchase of goods and service concurrently with the payment of periodic bills, such as the power company, etc.

This description provides example embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention. For example, well-known circuits, processes, algorithms, structures, and techniques have been shown without unnecessary detail in order to avoid obscuring the embodiments.

Thus, various embodiments may omit, substitute, or add, various procedures or components as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the preceding systems, methods, and software may individually or collectively be components of a larger system, wherein other procedures may take precedence over or otherwise modify their application. Also, a number of steps may be required before, after, or concurrently with the following embodiments.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

What is claimed is:

1. A television-based bill-payment system, the system comprising:
a television system, wherein the television system is configured to receive and transmit user-specific information and to display a user interface;
a television service provider network, wherein the television service provider network is operated by a television service provider, the television service provider network is configured to transmit and receive user-specific information with the television system and the television service provider network is configured to communicate with a bill payment provider;
the user interface, wherein the user interface is configured to display on the television system and provides a first user with a plurality of billers to select from and a plurality of funding sources to select from; and
a bill payment provider, wherein the bill payment provider is configured to communicate with the plurality of billers, the bill payment provider is configured to communicate with the first user through the television service provider network, the bill payment provider is configured to bill a funding source selected by the first user from the plurality of funding sources, and the bill payment provider is configured to transmit a payment confirmation to the biller.

2. The system of claim 1, wherein the bill payment provider and the television service provider are different providers.

3. The system of claim 1, wherein the television service provider network is a console gaming provider network.

4. The system of claim 1, wherein the funding source is cash physically provided to an agent of the bill payment provider.

5. The system of claim 1, wherein the funding source is a bank account.

6. The system of claim 1, further comprising a first account held by the first user with the bill payment provider.

7. The system of claim 6, further comprising a second account held by a second user with the television service provider, wherein television service provider services are billed to the second account.

8. The system of claim 7, wherein the first user and the second user are the same user.

9. The system of claim 1, wherein the first user is required to provide user identification information to the bill payment provider.

10. The system of claim 1, wherein the television service provider host network is a cable network, a satellite network, or a hotel network.

11. A method of making bill payments executed in connection with cable and/or satellite providers, the method comprising:
receiving a first set of billing information from a first biller regarding a first bill associated with a user;
storing the first set of billing information from the first biller regarding the first bill associated with the user on a computer-readable medium;
presenting an interface to the user on a television system via a television service provider's network;
receiving, at the bill payment provider, identification information from the user, via the television service provider's network, wherein the identification information is linked to an account of the user;
verifying, at the bill payment provider, the user's identification information;
transmitting, from the bill payment provider, at least a portion of the first set of billing information via a television service provider's network to the television system;
receiving, at the bill payment provider, a first selection of the bill from the user, via the television service provider's network;
storing, at the bill payment provider, a first selection of the bill from the user, on the computer readable-medium;
receiving, at the bill payment provider, a second selection of a funding source from the user, via the television service provider's network;
storing, at the bill payment provider, a second selection of a funding source from the user, on the computer readable-medium; and
transmitting, from the bill payment provider, a payment confirmation to the first biller.

12. The method of claim 11, further comprising:
transmitting, from the bill payment provider to the television system, a transaction identifier via the television service provider's network.

13. The method of claim 11, further comprising:
receiving, at the bill payment provider from an agent of the bill payment provider, a transaction identifier; and
receiving, at the bill payment provider from the agent of the bill payment provider, confirmation that a payment has been received for the first bill.

14. The method of claim 13, wherein the second selection is cash.

15. The method of claim 11, further comprising transmitting, from the bill payment provider, a confirmation of a bill payment.

16. The method of claim 11, wherein the account of the user is independent of the television service provider.

17. The method of claim 11, further comprising receiving a second set of billing information from a second biller regarding a second bill associated with the user, wherein the first biller and the second biller are different entities, and the first selection further includes the second bill.

18. The method of claim 17, further comprising:
transmitting, from the bill payment entity to the television system, a transaction identifier, via the television provider's network;
receiving, at the bill payment entity from an agent of the bill payment entity, a transaction identifier; and
receiving at the bill payment entity from the agent of the bill payment entity, confirmation that a payment for a total amount of the first bill and the second bill has been received.

19. A machine-readable medium having a set of instructions stored thereon for providing television-based user-independent payments executed in connection with cable and/or satellite providers which, when executed by a machine, cause the machine to:
receive, at the bill payment entity, a selection of an item or service for purchase via a television service provider network;
determine, at the bill payment entity, a biller associated with the selection of the item;
transmit, from the bill payment entity, a request for user identification information, via the television service provider network;
receive, at the bill payment entity, user identification information, via the television service provider network;
validate, at the bill payment entity, the user identification information;
receive, at the bill payment entity, a selection of a funding source from the user, via the television service provider network;
transmit, from the bill payment entity, a payment confirmation to the biller.

20. The method of claim 19, wherein the payment confirmation is substantially in real-time.

21. A method of executing bill payments through a television service provider, the method comprising:
transmitting, from the television service provider, an interface to a user on a television system;
receiving, at the television service provider, user identification information from the user, wherein the identification information is linked to an account of the user;
transmitting, from the television service provider, the user identification information to the billing party;
receiving, at the television service provider from the billing party, at least a first set of billing information;
transmitting, from the television service provider to the television system, at least a portion of the first set of billing information;
receiving, at the television service provider, a first selection of a bill from the user;
transmitting, from the television service provider, to the billing party, the first selection of the bill from the user;
receiving, at the television service provider, a second selection of a funding source from the user;
transmitting, from the television service provider, to the billing party, the second selection of the funding source from the user; and
receiving, at the television service provider, a payment confirmation from the billing party.

22. A method of receiving bill payments executed in connection with a television service provider, the method comprising:
creating, at a biller, a first set of billing information regarding a bill associated with a user;
storing, at the biller, the first set of billing information regarding the bill associated with the user on a first computer-readable storage device;
transmitting, from the biller, the first set of billing information to a bill payment provider;
receiving, at the biller, a confirmation that the user has paid the bill via a television service provider's network;
storing, at the biller, the confirmation that the user has paid the bill via the television service provider's network on a second computer readable storage device; and
receiving, at the biller from the billing service provider, at least a portion of the funds paid by the user for the bill.
